(19) United States
(12) Patent Application Publication
(10) Pub. No.: US 2014/0018474 A1
(43) Pub. Date: Jan. 16, 2014

(54) COMPOSITION FOR ANTI-SCRATCH AND WEAR-RESISTANCE PROPERTIES, METHOD OF PREPARING THE SAME, AND ITS APPLICATIONS

(71) Applicant: ETERNAL CHEMICAL CO., LTD., Kaohsiung (TW)

(72) Inventors: Lang Zhou, Kaohsiung (TW); Huanzhen Shao, Kaohsiung (TW); Junwei Hu, Kaohsiung (TW); Qingzhu Zhou, Kaohsiung (TW); Hung-Yu Wang, Kaohsiung (TW)

(73) Assignee: ETERNAL CHEMICAL CO., LTD., Kaohsiung (TW)

(21) Appl. No.: 13/719,311

(22) Filed: Dec. 19, 2012

(30) Foreign Application Priority Data
Jul. 16, 2012 (CN) 201210246270.1

(51) Int. Cl. C09D 5/00

(52) U.S. Cl. CPC C09D 5/00
USPC 523/457; 524/558; 524/560; 524/589; 523/400; 524/437; 523/466

(57) ABSTRACT

Provided are a composition for anti-scratch and wear-resistance properties, a method of preparing the same, and its application. The composition has inorganic particles, a dispersant and an organic binding agent. The inorganic particles are spherical and have an average particle size ranging from 10 nanometers to 999 nanometers. The dispersant has an inorganic dispersant and a polymer dispersant. The specific gravity of the inorganic particles and inorganic dispersant are respectively represented by s1 and s2, 0.05<s2/s1<1. The total amount of inorganic particles and inorganic dispersant ranges from 0.5 to 70 parts by weight, the amount of polymer dispersant ranges from 0.1 to 20 parts by weight, and the amount of organic binding agent ranges from 10 to 98 parts by weight. Since the inorganic particles are stably dispersed in the composition, the composition can be applied to coating, paint or composite materials and has improved wear-resistant and anti-scratch properties.

### CROSS-REFERENCE TO RELATED APPLICATION

Pursuant to 35 U.S.C. §119(a), this application claims the benefit of the priority to China Patent Application No. 201210246270.1, filed Jul. 16, 2012. The content of the prior application is incorporated herein by its entirety.

### BACKGROUND OF THE INVENTION

1. Field of the Invention

The invention relates to a composition for anti-scratch and wear-resistance properties, and more particularly to a composition comprised of well-dispersed inorganic particles to provide anti-scratch and wear-resistance properties.

2. Description of the Prior Arts

Generally, inorganic particles are added in a resin-based coating composition to provide a coating layer with improved hardness, wear-resistance and anti-scratch properties after film formation. Besides, the coating layer further has required transparency when the particle sizes of the inorganic particles are small enough, for example, submicron or nanometer scale.

However, the inorganic particles usually cannot be well dispersed in resins due to their poor affinity with resins, thus sedimentation of the inorganic particles in solvent or resins becomes more serious due to their heavier specific gravity.

In order to overcome the aforementioned problems, a large amount of polymer dispersants is used for modifying the surfaces of the inorganic particles, and improving the affinity between the inorganic particles and resins. Unfortunately, polymer dispersants having high molecular weight reduces hardness, slice-resistance and wear-resistance of product after film formation.

Thus, there is still a need to provide a novel composition which allows the inorganic particles to be well dispersed in the composition without sedimentation, and improves wear-resistance, anti-scratch properties and hardness of coating layer after film formation.

### SUMMARY OF THE INVENTION

To overcome the shortcomings of the conventional techniques, a primary objective of the present invention is to provide a composition for anti-scratch and wear-resistance properties.

Another objective of the present invention is to provide a method of preparing the composition for anti-scratch and wear-resistance properties.

Further another objective of the present invention is to apply the aforementioned composition to a plate for anti-scratch and wear-resistance properties.

To achieve the aforementioned objectives, the first aspect of the present invention is to provide a composition, comprising:

(a) inorganic particles being spherical and having an average particle size ranging from 10 nanometers to 999 nanometers;

(b) a dispersant including an inorganic dispersant and a polymer dispersant; and

(c) an organic binding agent;

wherein the inorganic particles have a specific gravity represented by s1, the inorganic dispersant has a specific gravity represented by s2, 0.05<s2/s1<1, the total amount of the inorganic particles and the inorganic dispersant ranges from 0.5 to 70 parts by weight, the amount of the polymer dispersant ranges from 0.1 to 20 parts by weight, and the amount of the organic binding agent ranges from 10 to 98 parts by weight.

Preferably, the overall weight of the composition ranges from 80 to 120 parts by weight, and more preferably ranges from 90 to 110 parts by weight.

Preferably, the overall weight of the composition is 100 parts by weight.

Preferably, the total amount of the inorganic particles and the inorganic dispersant ranges from 0.5 to 70 parts by weight, the amount of the polymer dispersant ranges from 0.1 to 20 parts by weight, and the amount of the organic binding agent ranges from 10 to 98 parts by weight based on the overall weight of the composition ranging from 80 to 120 parts by weight.

Preferably, the total amount of the inorganic particles and the inorganic dispersant ranges from 0.5 to 70 parts by weight, the amount of the polymer dispersant ranges from 0.1 to 20 parts by weight, and the amount of the organic binding agent ranges from 10 to 98 parts by weight based on the overall weight of the composition ranging from 90 to 110 parts by weight.

Preferably, the total amount of the inorganic particles and the inorganic dispersant ranges from 0.5 to 70 parts by weight, the amount of the polymer dispersant ranges from 0.1 to 20 parts by weight, and the amount of the organic binding agent ranges from 10 to 98 parts by weight based on the overall weight of the composition being 100 parts by weight.

Preferably, if the specific gravity of the inorganic particles is represented by s1 and the specific gravity of the inorganic dispersant is represented by s2, 0.08<s2/s1<0.8, and more preferably 0.1<s2/s1<0.7.

Preferably, the weight ratio of the inorganic dispersant to the inorganic particles ranges from 0.02:1 to 10:1, and more preferably from 0.1:1 to 5:1.

Preferably, the inorganic particles are spherical and have an average particle size ranging from 80 nanometers (nm) to 600 nanometers.

Preferably, the inorganic particles are selected from: metallic oxide particles, ceramic particles or the combinations thereof.

Preferably, said metallic oxide particles are selected from: aluminum oxide (Al₂O₃), zinc oxide (ZnO), zirconium dioxide (ZrO₂), cerium dioxide (CeO₂), titanium dioxide (TiO₂) or the combinations thereof.

Preferably, said ceramic particles are selected from: aluminum oxide, silicon dioxide or the combinations thereof.

Preferably, the amount of the inorganic particles ranges from 0.25 to 50 parts by weight based on the overall weight of the composition being 100 parts by weight.

Preferably, the amount of the inorganic particles ranges from 0.5 to 50 parts by weight, and more preferably ranges from 5 to 50 parts by weight based on the overall weight of the composition being 100 parts by weight.

Preferably, the inorganic dispersant is selected from aluminum oxide, silicon dioxide, zinc oxide, zirconium dioxide, cerium dioxide, titanium dioxide or the combinations thereof.

Preferably, the inorganic dispersant has a shape that is irregular, or porous, or is in the shape of a sheet or a stick.

Preferably, the amount of the inorganic dispersant ranges from 0.1 to 30 parts by weight based on the overall weight of the composition being 100 parts by weight.

Preferably, the amount of the inorganic dispersant ranges from 0.2 to 25 parts by weight, and more preferably ranges from 2 to 25 parts by weight based on the overall weight of the composition being 100 parts by weight.

Preferably, the polymer dispersant is selected from the group consisting of: polyacrylate, polyester, polyamide, polyurethane, polyimide, polyurea, polyether, polysiloxane, fatty acid ester and the combinations thereof.

Preferably, the organic binding agent is selected from the group consisting of: polyether, polyurethane, acrylate, unsaturated polyester resin, epoxy compound, polyamide, melamine, polyolefin, polystyrene, polysiloxane resin, fluorinated polymer resin and the combinations thereof.

Preferably, the acrylate is acrylate-based monomer. The acrylate-based monomer applicable to the present invention has at least one functional group. For example, the acrylate-based monomer includes 2-phenoxy ethyl acrylate, ethoxylated phenoxy acrylate, cyclic trimethylolpropane formal acrylate, isodecyl acrylate, isobornyl(meth)acrylate, 2-hydroxyethyl acrylate, 2-hydroxyethyl(meth)acrylate, dipropylene glycol di(meth)acrylate, tripropylene glycol di(meth)acrylate, 1,6-hexanediol di(meth)acrylate, diethylene glycol di(meth)acrylate, polyethylene glycol (400) diacrylate, trimethylolpropane triacrylate, ethoxylated trimethylolpropane triacrylate, propoxylated glycerol tri(meth)acrylate, pentaerythritol triacrylate, pentaerythritol tetraacrylate or dipentaerythritol hexaacrylate, but is not limited thereto.

Preferably, the acrylate is tripropylene glycol di(meth)acrylate, 1,6-hexanediol di(meth)acrylate or isobornyl(meth)acrylate.

Preferably, the amount of the polymer dispersant ranges from 0.3 to 15 parts by weight based on the overall weight of the composition being 100 parts by weight.

Preferably, the amount of the organic binding agent ranges from 30 to 80 parts by weight based on the overall weight of the composition being 100 parts by weight.

To achieve the aforementioned objectives, the second aspect of the present invention is to provide a method of preparing the composition, comprising the steps of:

(a) mixing thoroughly a polymer dispersant and an organic binding agent to form a first mixture;

(b) adding the inorganic particles and inorganic dispersant into the first mixture obtained in the aforementioned step (a) to form a second mixture; and

(c) wet grinding the second mixture obtained in the aforementioned step (b) to obtain the composition.

Preferably, the step (c) further comprises the step of wet grinding the second mixture obtained in the step (b) by using grinding media with a particle size ranging from 0.01 millimeters to 1 millimeter.

To achieve the aforementioned objectives, the third aspect of the present invention is to provide the applications of the composition, including applying the composition to prepare a coating composition or applying the composition to prepare a plate for anti-scratch and wear-resistance properties.

Preferably, the coating composition comprises the composition provided by the first aspect, a resin, an additive, and a photo initiator.

To achieve the aforementioned objectives, the fourth aspect of the present invention is to provide a plate with anti-scratch and wear-resistance properties. The plate comprises a substrate and a coating layer, wherein the coating layer is formed by curing a coating composition coated on at least one surface of the substrate, and the coating composition comprises the composition provided by the first aspect.

Preferably, the coating composition further comprises a resin, an additive and a photo initiator.

Preferably, the plate with anti-scratch and wear-resistance properties has a gloss more than 85 gloss unit (GU) measured at an angle of 60°.

Preferably, the substrate is a plastic substrate.

Preferably, the wear-resistance of the coating layer is tested by using 0000# steel wool with a force of 500g. No scratch is observed on the surface of the coating layer.

Preferably, the coating composition is coated on the substrate by spray coating, roll coating, flow coating and dip coating, and is cured to form the coating layer.

Beneficial Effects

The present invention provides an anti-scratch and wear-resistant composition comprising well-dispersed inorganic particles to stably disperse the inorganic particles in the composition without sedimentation, and to improve hardness, wear-resistance and anti-scratch properties of the coating layer after film formation.

It should be understood that each technical feature mentioned above and each specific technical feature described in the following paragraphs (such as examples) can be combined with each other, and thereby construct a novel or preferable technical aspect. For length concern, the combinations are not described in detail.

### DETAILED DESCRIPTION OF THE PREFERRED EMBODIMENTS

The inventors of the present application conducts an extensive and deep research and develops a composition comprising inorganic particles, an inorganic dispersant, a polymer dispersant and an organic binding agent. Said inorganic particles are able to disperse thoroughly in the composition, and the present invention is accomplished.

Composition

The composition of the present invention comprises the following components:

(a) inorganic particles, the inorganic particles are spherical and have an average particle size ranging from 10 nanometers to 999 nanometers;

(b) a dispersant, the dispersant includes an inorganic dispersant and a polymer dispersant; and

(c) an organic binding agent;

wherein the inorganic particles have a specific gravity represented by s1, the inorganic dispersant has a specific gravity represented by s2, 0.05<s2/s1<1,

wherein the total amount of inorganic particles and the inorganic dispersant ranges from 0.5 to 70 parts by weight, the polymer dispersant ranges from 0.1 to 20 parts by weight, and the organic binding agent ranges from 10 to 98 parts by weight.

Preferably, the overall weight of the composition ranges from 80 to 120 parts by weight, and more preferably ranges from 90 to 110 parts by weight.

Preferably, the overall weight of the composition is 100 parts by weight.

In accordance with the present invention, the composition mitigates the problem that the spherical inorganic particles tend to settle down in the composition.

Inorganic Particles

The component (a) inorganic particles used in the present invention are an inorganic material mainly providing the composition for wear-resistance and anti-scratch properties.

The inorganic particles applicable to the present invention are metallic oxide particles, ceramic particles or the mixtures thereof. The metallic oxide particles may be at least one oxide selected from: aluminum oxide, zinc oxide, zirconium dioxide, cerium dioxide, titanium dioxide or the combinations thereof, but are not limited thereto. The ceramic particles are, for example, aluminum oxide, silicon dioxide (SiO₂) and/or the combinations thereof, but are not limited thereto.

The inorganic particles applicable to the present invention comprises: spherical aluminum oxide particles (trade name: AO802, manufactured by Admatechs Corporation in Japan); spherical aluminum oxide particles (trade name: Z060, manufactured by Tekna Corporation); spherical aluminum oxide particles (trade names: AFSP-20, UFP-20, UFP-30, UFP-40, all manufactured by Denka Electronic Materials Company in Japan); and spherical silicon dioxide particles (trade names: SO-C1, SO-C2, SO-E1, SO-E2, all manufactured by Micron Co., Ltd. in Japan)

In accordance with the embodiment of the present invention, if the component (a) is formed in a spherical shape, the anti-scratching and wear-resistant properties of the composition can be improved. Moreover, because the inorganic particles have lower surface area, the mobility of the composites composed of organic resin and inorganic particles and the slip smoothness of the coating layer after curing are improved.

The particle size of the component (a) inorganic particles used in the present invention can be modified according to the desired properties of the composition. In accordance with the embodiment of the present invention, the component (a) inorganic particles may have an average particle size ranging from 10 nanometers to 999 nanometers, preferably ranging from 25 nanometers to 500 nanometers, and more preferably ranging from 30 nanometers to 300 nanometers. If the average particle size of the inorganic particles is less than 10 nanometers, the aggregation among inorganic particles is too serious, preventing the inorganic particles from dispersing well in the composition; but when the average particle size is more than 999 nanometers, the transmittance of light is significantly influenced, thereby reducing the transparency of the composition.

In accordance with the present invention, the usage amount of the component (a) inorganic particles is not particularly limited, and can be modified by the species and usages thereof in the composition. Generally, the usage amount of the inorganic particles ranges from 0.25 to 50 parts by weight, and preferably ranges from 0.5 to 45 parts by weight based on the overall weight of the composition being 100 parts by weight. If the usage amount of the inorganic particles is less than 0.25 parts by weight, the composition cannot have sufficient wear-resistance and anti-scratch properties; but when more than 50 parts by weight in usage amount, the inorganic particles settle down too fast in the composition due to the reduced dispersion stability, and thereby lowering the application value of the composition.

Dispersant

The component (b) dispersant used in the present invention is mainly to provide the component (a) inorganic particles with dispersing stability in a resin or solvent, and thereby prevent the inorganic particles from settling down.

The dispersant of the present invention comprises two components: (b1) inorganic dispersant and (b2) polymer dispersant. The component (b1) inorganic dispersant is used to improve the dispersion stability of the inorganic particles, and further used to solve the problems of poor wear-resistance and anti-scratch properties resulted from the component (b2) polymer dispersant in the composition.

In accordance with the embodiment of the present invention, the species of component (b1) inorganic dispersant may be identical with or different from that of the inorganic particles, which is at least one oxide selected from: aluminum oxide, silicon dioxide (SiO₂), zinc oxide, zirconium dioxide, cerium dioxide, titanium dioxide and the combinations thereof. The inorganic dispersant applicable to the present invention comprises: aluminum oxide (trade name: SpectrAL®51, SpectrAL®81, SpectrAL® 100, all manufactured by Cabot Corporation); aluminum oxide (trade names: AEROXIDE® AlUC130, AEROXIDE® AluC, AEROXIDE® Aluc 805, all manufactured by Evonick Degussa Company); silicon dioxide (trade names: HDK®V15, HDK® N20, HDK® C10, A200, all manufactured by Cabot Corporation); silicon dioxide (trade names: TS-100, A-200, OK500, OK 607, all manufactured by Cabot Corporation)

The component (b1) inorganic dispersant used in the present invention has a shape composed partially of air, resulting that the inorganic dispersant has a specific gravity less than that of the component (a) inorganic particles. Thus, the sedimentation of the inorganic particles occurring in a resin or solvent due to their larger specific gravity can be mitigated.

In accordance with one of the embodiments of the present invention, the inorganic dispersant has a shape selected from an irregular shape, a porous shape, a shape of a sheet, and a shape of a stick. Wherein, the inorganic particles have a specific gravity represented by s1, the inorganic dispersant has a specific gravity represented by s2, 0.05<s2/s1<1, preferably 0.08<s2/s1<0.8, and more preferably 0.1<s2/s1<0.7.

In accordance with the present invention, the usage amount of the component (b1) inorganic dispersant is not particularly limited, and can be modified by the species and usage amounts thereof comprised in the composition. Generally, the usage amount of the inorganic dispersant ranges from 0.1 to 30 parts by weight, and preferably ranges from 0.2 to 25 parts by weight based on the overall weight of the composition being 100 parts by weight.

The component (b2) polymer dispersant used in the present invention mainly enables the component (a) inorganic particles to have good affinity with the component (c) organic binding agent and to have improved dispersion stability. The component (b2) polymer applicable to the present invention has a molecular weight more than 1000 and includes one or multiple groups being able to react with the surface of the inorganic particles. The polymer dispersant is selected from the group consisting of: polyacrylate, polyester or polyurethane, but is not limited thereto. The polymer dispersant is fixed on the surface of the inorganic particles through at least one interaction among acidic interaction, basic interaction, neutral interaction, and covalent interaction. The polymer dispersant applicable to the present invention comprises, but is not limited to: BYK 163, BYK180, BYK2009, BYK2155 (manufactured by BYK Chemical Company in Germany); Solsperse 24000, Solsperse 32000, Solsperse 36000, Solsperse 39000, Solsperse 71000 (manufactured by Lubrizol Chemical Company in U.S.A.); Dispers 610, Dispers 630, Dispers 650, Dispers 655 (manufactured by Evonick Degussa in Germany) In accordance with the present invention, the usage amount of the component (b2) polymer dispersant is not particularly limited, and can be modified by the species and usage amounts thereof comprised in the composition. Generally, the usage amount of the polymer dispersant ranges from 0.1 to 20 parts by weight, and preferably ranges from 0.3 to 15 parts by weight based on the overall weight of the composition being 100 parts by weight.

Organic Binding Agent

The component (c) organic binding agent used in the present invention can provide the composition for required physical properties during film formation.

The component (c) organic binding agent applicable to the present invention may be selected from the group consisting of: polyether, polyurethane, acrylate, unsaturated polyester resin, epoxy compound, polyamide, melamine, polyolefin, polystyrene, polysiloxane resin, fluorinated polymer resin and the mixtures thereof, but is not limited thereto. Preferably, the component (c) organic binding agent comprises: polyurethane, acrylate, unsaturated polyester resin or epoxy compound; and more preferably, acrylate.

Abovementioned acrylate includes acrylate-based monomer and acrylate-based oligomer. The acrylate-based monomer applicable to the present invention has at least one functional group, such as 2-phenoxy ethyl acrylate, ethoxylated phenoxyl acrylate, cyclic trimethylolpropane formal acrylate, isodecyl acrylate, isobornyl(meth)acrylate, hydroxyethyl acrylate (HEA), 2-hydroxyethyl(meth)acrylate (HEMA), dipropylene glycol di(meth)acrylate, tripropylene glycol di(meth)acrylate, 1,6-hexanediol di(meth)acrylate, diethylene glycol di(meth)acrylate, polyethylene glycol (400) diacrylate (PEG(400)DA), trimethylolpropane triacrylate, ethoxylated trimethylolpropane triacrylate, propoxylated glycerol tri(meth)acrylate, pentaerythritol triacrylate, pentaerythritol tetraacrylate, dipentaerythritol hexaacrylate (DPHA). Preferably, the acrylate is tripropylene glycol di(meth)acrylate, 1,6-hexanediol di(meth)acrylate, or isobornyl(meth)acrylate, but is not limited thereto. The acrylate-based oligomer applicable to the present invention is selected from the group consisting of: acrylate oligomer, polyacrylate, polyurethane acrylate, propylene oxide acrylate, polyester acrylate and the combinations thereof, but are not limited thereto.

The organic binding agent applicable to the present invention comprises, but is not limited to: polyurethane such as Etercure 6112-100, Etercure 6130B-30, Etercure 6145-100, Etercure 6153-1, Etercure 6195-100, Etercure 6196-100, Etercure 6161-100; epoxy resin such as Etercure 621-100, Etercure 6210G, Etercure 6215-100, Etercure 6234, Etercure 623A-80; polyester such as Etercure 6315, Etercure 601Q-35, Etercure 604Q-35, Etercure 6320; acrylate monomer such as EM210, EM2103, EM2104, EM212, EM 219, EM223, EM221, EM222, EM223, EM2251, EM 231, EM235, EM2380, EM2387, EM241, EM265; or unsaturated polyester resin such as Eterset 2303, Eterset2306-2, Eterset 2307S manufactured by Eternal Chemical Co., Ltd.

According to the present invention, the usage amount of the component (c) organic binding agent is not particularly limited, and can be modified by the species and usage amount thereof comprised in the composition. Generally, the amount of the organic binding agent ranges from 20 to 98 parts by weight, preferably ranges from 30 to 80 parts by weight based on the overall weight of the composition being 100 parts by weight.

Preparation Method of the Composition

The present invention provides a method of preparing an anti-scratch and wear-resistant composition, comprising the steps of:

(a) mixing a polymer dispersant and an organic binding agent to form a first mixture;

(b) adding inorganic particles and an inorganic dispersant into the first mixture obtained in the aforementioned step (a) to form a second mixture; and

(c) wet grinding the second mixture obtained in the aforementioned step (b) to prepare the composition.

In the wet grinding step, all components comprised in the composition are agitated at high speed to be dispersed well in the composition. Herein, high-speed dispersion technology comprises wet grinding known to the present invention and three rollers milling for mass production. In accordance with one embodiment of the present invention, the grinding media have a particle size in a range from 0.01 nanometers to 1 nanometer, and more preferably from 0.02 nanometers to 0.5 nanometers. According to the present invention, the grinding media used in the nano wet grinding are micrometer-scale or nanometer scale to provide nano or submicron inorganic particles with good dispersion stability in the composition of the present invention.

In accordance with the present invention, when the organic binding agent has larger viscosity, it can be added in and grinded with any solvents commonly used in the technical fields, such as propylene glycol methyl ether acetate (PMA), propylene glycol methyl ether (PM), dipropylene glycol monomethyl ether (DMP), propylene glycol, tripropylene glycol monomethyl ether (TPM), butyl acetate, ethylene glycol butyl ether or the mixtures thereof.

Applications of the Composition

The composition of the present invention can be applied to prepare paints, coatings and electronic packaging materials.

The composition of the present invention can be applied to a plate with anti-scratch and wear-resistance properties. The plate comprises a substrate and a coating layer formed on at least one surface of the substrate, and the coating layer is made from the coating composition. For example, the coating composition can be coated on at least one surface of the substrate to form at least one coating film, and then form a coating layer after curing. Said coating process can be performed by spray coating, roll coating, flow coating and dip coating, and preferably by spray coating. The curing process may be heat curing, photo curing or their combinations. In accordance with one embodiment of the present invention, the photo curing is UV curing. Said substrate is not particularly limited. In accordance with the embodiment of the present invention, the substrate is a plastic substrate. The plastic substrate applicable to the present invention includes, but is not limited to: acrylonitrile, graft copolymer composed of acrylonitrile, 1,3-butadiene and styrene (ABS), polycarbonate resin (PC), polypropylene (PP), polymethyl(meth)acrylate (PMMA), polystyrene (PS) or the combinations thereof.

Said coating composition comprises the composition of the present invention, and further comprises a resin, an additive and a photo initiator.

By using the composition of the present invention to prepare the coating composition, it allows the coating film to have improved wear-resistance, anti-slice properties and heat conductivity, and to maintain its transparency after film formation.

The resin may be identical with or different from the aforementioned organic binding agent, and may be any one known to a person skilled in the art. The resin applicable to the present invention comprises, but is not limited to: acrylated-based monomer or acrylate-based oligomer. Said acrylate-based oligomer comprises, for example, but is not limited to, acrylate oligomer, polyurethane acrylate, propylene oxide acrylate, polyester acrylate or the combinations thereof. The amount of the resin ranges from 10 to 70 parts by weight based on the overall weight of the composition being 100 parts by weight.

The resin applicable to the present invention includes: di-functional polyurethane acrylate (trade names: Etercure 6112-100, Etercure 6130B-30,); hexa-functional polyurethane acrylate (trade names: Etercure 6145-100, Etercure 6195-100, Etercure 6196-100, Etercure 6161-100), propylene oxide acrylate (trade names: Etercure 621-100, Etercure 6210G, Etercure 6215-100, Etercure 623A-80) or polyester acrylate (trade names: Etercure 6315, Etercure 601Q-35, Etercure 604Q-35), all manufactured by Eternal Chemical Co., Ltd.

The additive may be any one known to a person skilled in the art. The additive applicable to a plastic substrate of the present invention may be selected from the group consisting of: wetting agent, leveling agent, foam inhibiting agent, dispersant and the combinations thereof, but is not limited thereto. The amount of the additive agent ranges from 0.1 to 10 parts by weight based on the overall weight of the composition being 100 parts by weight.

The photo initiator may be any one known to a person skilled in the art. The photo initiator applicable to the present invention is, for example, but not limited to: 1-hydroxycyclohexyl phenyl ketone (trade name: PI 184); 2-hydroxy-2-methyl-1-phenyl-1-propanone (trade name: PI 1173); benzophenone (trade name: PI BP); 2,4,6-trimethylbenzoyl diphenylphosphine oxide (trade name: PI TPO); 2-methyl-1-[4-(methylthio)phenyl]-2-morpholinopropan-1-one (trade name: PI 907). The amount of the photo initiator ranges from 1 to 10 parts by weight based on the overall weight of the composition being 100 parts by weight.

The composition of the present invention may optionally comprise a solvent, which is selected from organic solvent, water or their combinations. Wherein, the organic solvent is: ethyl acetate, butyl acetate, isopropanol, n-butanol, 2-butanol, dimethylbenzene, methyl ethyl ketone, cyclohexanone, ethylene glycol monobutyl ether or the mixtures thereof. The amount of the solvent ranges from 0 to 60 parts by weight based on the overall weight of the composition being 100 parts by weight.

The technical features as mentioned in the specification or in the examples can be combined in any way, and all technical features disclosed by the specification can be incorporated with any combinations. Each technical feature disclosed by the technical features also can be replaced by any substitutes that provide the same, equivalent or similar objects. Therefore, all technical features disclosed herein are merely equivalent or similar ones in general examples except for unusual remarks.

The following examples are to further illustrate the present invention. It should be understood that the examples are merely used to illustrate the present invention, but not intended to limit the scope of the present invention. The experimental methods of the following examples, which are not described in detail, are generally performed in common or in accordance with the process provided by manufacturer.

Unless otherwise defined, all specific and scientific terms presented in the paragraphs express a same meaning known to a person with ordinary knowledge in the art. Besides, any methods and materials similar to or equivalent to those as described can be applied to the present invention, and the preferred embodiments and materials described in the paragraphs are just provided in an exemplary use.

### Comparative Examples 1-9

### Preparation of Composition

The polymer dispersant was mixed with the organic binding agent first, and then mixed with the inorganic particles to obtain a mixture. Subsequently, the mixture was mixed with grinding media (zirconium beads with particle sizes ranging from 0.05 millimeters to 1 millimeter) in the grinding apparatus (JBM-C020, Just Nanotech Co., Ltd. in Taiwan), and wet grinded at a rotational speed from 1800 rpm to 3000 rpm to obtain the composition. Specific components and their contents in the compositions of Comparative Examples 1-9 are listed in the following Table 1. All units of contents presented in Table 1 are parts by weight. The components as shown in Table 1 are:

a1: spherical aluminum oxide (inorganic particles), trade name: Z060 (average particle size: 105 nm), manufactured by Tekna Corporation;

a2: spherical silicon dioxide particles, trade name: SO-E1 (average particle size: 120 nm), manufactured by Micron Co., Ltd.;

a3: spherical silicon dioxide particles, trade name: S0-E2 (average particle size: 180 nm), manufactured by Micron Co., Ltd.;

a4: spherical aluminum oxide (inorganic particles), trade name: UFP-20 (average particle size: 210 nm), manufactured by Denka Electronic Materials Company;

a5: spherical aluminum oxide (inorganic particles), trade name: UFP-40 (average particle size: 350 nm), manufactured by Denka Electronic Materials Company;

a6: spherical aluminum oxide (inorganic particles), trade name: AO-802 (average particle size: 510 nm), manufactured by Admatechs Corporation;

b21: polymer dispersant, trade name: BYK 180, manufactured by BYK Chemical Company;

b22: polymer dispersant, trade name: BYK2009, manufactured by BYK Chemical Company;

b23: polymer dispersant, trade name: BYK163, manufactured by BYK Chemical Company;

b24: polymer dispersant, trade name: Solsperse 71000, manufactured by Lubrizol Chemical Company;

c1: tripropylene glycol diacrylate, trade name: TPGDA, trade name: EM223, manufactured by Eternal Chemical Co., Ltd.;

c2: 1,6-hexanediol di(meth)acrylate, trade name: EM221, manufactured by Eternal Chemical Co., Ltd.;

c3: isobornyl(meth)acrylate, trade name: EM 70, manufactured by Eternal Chemical Co., Ltd.;

c4: polyurethane, trade name: 6153-1, manufactured by Eternal Chemical Co., Ltd.;

c5: epoxy resin, trade name: 6234, manufactured by Eternal Chemical Co., Ltd.; and

c6: polyester, trade name: 6320, manufactured by Eternal Chemical Co., Ltd.

TABLE 1
components and their contents of the compositions in Comparative Examples 1-9

| | Comparative Example No. | | | | | | | | |
|---|---|---|---|---|---|---|---|---|---|
| Composition | 1 | 2 | 3 | 4 | 5 | 6 | 7 | 8 | 9 |
| Component | a1 | a2 | a3 | a4 | a5 | a6 | a4 | a5 | a6 |
| Content | 10 | 15 | 20 | 25 | 35 | 45 | 40 | 42 | 28 |
| Component | b21 | b21 | b22 | b22 | b23 | b23 | b24 | b24 | b24 |
| Content | 20.5 | 20 | 15 | 10 | 20 | 15 | 40 | 42 | 28 |
| Component | c1 | c1 | c2 | c2 | c3 | c3 | c4 | c5 | c6 |
| Content | 69.5 | 65 | 65 | 65 | 45 | 40 | 20 | 16 | 44 |
| Total Content | 100 | 100 | 100 | 100 | 100 | 100 | 100 | 100 | 100 |

The properties of the compositions prepared by Comparative Examples 1-9 were measured and evaluated with the following instruments and analysis conditions:

The viscosity of the composition was measured by Brookfield viscometer. Particle size was measured by laser particle size analyzer (Malvern-ZEN 3690, Malvern instruments Ltd.). Wherein, the combined particle sizes presented in Table 2 were obtained from the measurement of the particle size of inorganic particles mixed with the dispersant and organic binding agent in the composition. Particle size (1D) was obtained from the measurement of the inorganic particles of the composition after 1 day standing, and particle size (1M) is obtained from the measurement of those after 30 days standing. The dispersion stability of inorganic particles was measured by laser particle size analyzer (Malvern-ZEN 3690, Malvern instruments Ltd.) and stood quietly at room temperature.

TABLE 2
stability test results of the compositions prepared by Comparative Examples 1-9

| | Comparative Example No. | | | | | | | | |
|---|---|---|---|---|---|---|---|---|---|
| Test Items | 1 | 2 | 3 | 4 | 5 | 6 | 7 | 8 | 9 |
| Viscosity | 85 | 115 | 108 | 96 | 70 | 130 | 250 | 310 | 110 |
| (cps, 25° C.) | | | | | | | | | |
| Combined | 108 | 130 | 185 | 220 | 354 | 516 | 225 | 360 | 520 |
| Particle Size | | | | | | | | | |
| (nm) | | | | | | | | | |
| Dispersion | ◯ | ◯ | ◯ | ◯ | ◯- | ◯- | ◯ | ◯- | ◯- |
| Stability (1D) | | | | | | | | | |
| Particle Size | 108 | 135 | 190 | 212 | 350 | 510 | 230 | 365 | 515 |
| (1D) (nm) | | | | | | | | | |
| Dispersion | X | X | X | X | X | X | X | X | X |
| Stability (1M) | | | | | | | | | |
| Particle Size | 150 | 230 | 212 | 355 | 570 | 841 | 370 | 580 | 823 |
| (1M) (nm) | | | | | | | | | |

As shown in Table 2, the dispersion stability (1D) was obtained by the measurement of the compositions after 1 day standing, and the dispersion stability (1M) was obtained by the measurement of the composition after 30 days standing. “O” indicated that no inorganic particles settled down, “0-” indicated that a little inorganic particles settled down, and “X” indicated that large amount of inorganic particles settled down and were aggregated.

Aforementioned results demonstrate that obvious sedimentations and aggregations of the inorganic particles are observed after 30 days standing.

### Examples 1-9

### Preparation of Composition

The polymer dispersant was mixed with the organic binding agent first, and then mixed with the inorganic particles to obtain a mixture. Subsequently, the mixture was further mixed with grinding media (zirconium beads with particle sizes ranging from 0.05 millimeters to 1 millimeter) in the grinding apparatus (JBM-C020, Just Nanotech Co., Ltd. in Taiwan), and wet grinded at a rotational speed from 1800 rpm to 3000 rpm to obtain the composition. Specific components and their content in compositions of Examples 1-6 are listed in the following Table 3. All units of contents presented in Table 3 are parts by weight. The components as shown in Table 3 are:

a1: spherical aluminum oxide (inorganic particles), trade name: Z060 (average particle size: 105 nm), manufactured by Tekna Corporation;

a2: spherical silicon dioxide particles, trade name: SO-E1 (average particle size: 120 nm), manufactured by Micron Co., Ltd.;

a3: spherical silicon dioxide particles, trade name: S0-E2 (average particle size: 180 nm), manufactured by Micron Co., Ltd.;

a4: spherical aluminum oxide (inorganic particles), trade name: UFP-20 (average particle size: 210 nm), manufactured by Denka Electronic Materials Company;

a5: spherical aluminum oxide (inorganic particles), trade name: UFP-40 (average particle size: 350 nm), manufactured by Denka Electronic Materials Company;

a6: spherical aluminum oxide (inorganic particles), trade name: AO-802 (average particle size: 510 nm), manufactured by Admatechs Corporation;

b11: irregular silicon dioxide (inorganic dispersant), trade name: A-200, manufactured by Evonick Degussa Company;

b12: irregular aluminum oxide (inorganic dispersant), trade name: SpectrAl® 51, manufactured by Cabot Corporation;

b21: polymer dispersant, trade name: BYK 180, manufactured by BYK Chemical Company;

b22: polymer dispersant, trade name: BYK2009, manufactured by BYK Chemical Company;

b23: polymer dispersant, trade name: BYK163, manufactured by BYK Chemical Company;

b24: polymer dispersant, trade name: Solsperse 71000, manufactured by Lubrizol Chemical company;

c1: tripropylene glycol diacrylate (TPGDA), trade name: EM223, manufactured by Eternal Chemical Co., Ltd.;

c2: 1,6-hexanediol di(meth)acrylate, trade name: EM221, manufactured by Eternal Chemical Co., Ltd.;

c3: isobornyl(meth)acrylate, trade name: EM 70, manufactured by Eternal Chemical Co., Ltd.;

c4: polyurethane, trade name: 6153-1, manufactured by Eternal Chemical Co., Ltd.;

c5: epoxy resin, trade name: 6234, manufactured by Eternal Chemical Co., Ltd.; and

c6: polyester, trade name: 6320, manufactured by Eternal Chemical Co., Ltd.

TABLE 3
components and their contents of the compositions in Examples 1-9

| | Example No. | | | | | | | | |
|---|---|---|---|---|---|---|---|---|---|
| Compositions | 1 | 2 | 3 | 4 | 5 | 6 | 7 | 8 | 9 |
| Component | a1 | a2 | a3 | a4 | a5 | a6 | a4 | a5 | a6 |
| Specific | 0.51 | 0.55 | 0.62 | 0.65 | 0.70 | 0.85 | 0.65 | 0.70 | 0.85 |
| Gravity s1 | | | | | | | | | |
| Content | 10 | 15 | 20 | 25 | 35 | 45 | 40 | 42 | 28 |
| Component | b11 | b11 | b11 | b12 | b12 | b12 | b12 | b12 | b12 |
| Content | 20 | 15 | 10 | 5 | 5 | 10 | 20 | 25 | 14 |
| Specific | 0.08 | 0.08 | 0.08 | 0.32 | 0.32 | 0.32 | 0.32 | 0.32 | 0.32 |
| Gravity s2 | | | | | | | | | |
| Component | b21 | b21 | b22 | b22 | b23 | b23 | b24 | b24 | b24 |
| Content | 0.5 | 5 | 5 | 5 | 15 | 5 | 20 | 17 | 14 |
| Component | c1 | c1 | c2 | c2 | c3 | c3 | c4 | c5 | c6 |
| Content | 69.5 | 65 | 65 | 65 | 45 | 40 | 20 | 16 | 44 |
| Total Content | 100 | 100 | 100 | 100 | 100 | 100 | 100 | 100 | 100 |

The properties of the compositions prepared by Examples 1-9 were measured and evaluated with the following instruments and analysis conditions.

The viscosity of the composition was measured by Brookfield viscometer. The particle size was measured by laser particle size analyzer (Malvern-ZEN 3690, Malvern Instruments Ltd.). Wherein, the combined particle sizes presented in Table 4 is obtained from the measurement of the particle size of inorganic particles mixed with the dispersant and organic binding agent in the composition. Particle size (1D) is obtained from the measurement of the inorganic particles of the composition after 1 day standing, and particle size (1M) is obtained from the measurement of those after 30 days standing. The dispersion stability of inorganic particles was measured by laser particle size analyzer (Malvern-ZEN 3690, Malvern Instruments Ltd.) and stood at room temperature.

TABLE 4
stability test results of the compositions prepared by Examples 1-9

| | Example No. | | | | | | | | |
|---|---|---|---|---|---|---|---|---|---|
| Test Items | 1 | 2 | 3 | 4 | 5 | 6 | 7 | 8 | 9 |
| s2/s1 | 0.16 | 0.15 | 0.13 | 0.49 | 0.46 | 0.37 | 0.49 | 0.46 | 0.37 |
| Viscosity | 160 | 130 | 108 | 96 | 70 | 130 | 300 | 395 | 150 |
| (cps, 25° C.) | | | | | | | | | |
| Combined | 56 | 70 | 135 | 176 | 310 | 480 | 186 | 347 | 490 |
| Particle Size | | | | | | | | | |
| (nm) | | | | | | | | | |
| Dispersion | ◯ | ◯ | ◯ | ◯ | ◯ | ◯ | ◯ | ◯ | ◯ |
| Stability (1D) | | | | | | | | | |
| Particle Size | 58 | 70 | 130 | 173 | 300 | 475 | 185 | 345 | 491 |
| (1D) (nm) | | | | | | | | | |
| Dispersion | ◯- | ◯ | ◯ | ◯ | ◯ | ◯- | ◯ | ◯ | ◯- |
| Stability | | | | | | | | | |
| (1M) | | | | | | | | | |
| Particle Size | 62 | 75 | 135 | 175 | 305 | 475 | 185 | 345 | 491 |
| (1M) (nm) | | | | | | | | | |

As shown in Table 4, the dispersion stability (1D) was obtained by the measurement of the compositions after 1 day standing, and the dispersion stability (1M) was obtained by the measurement of the composition after 30 days standing. “O” indicated that no inorganic particles settled down, “O-” indicated that a little amount of inorganic particles settled down, and “X” indicated that large amount of inorganic particles settled down and were aggregated.

Each composition of Examples in accordance with the present invention is added with the inorganic dispersant. In comparison with the test results of Comparative Examples 1-9, aforementioned results demonstrate that the inorganic particles are still stably dispersed in the composition and are not aggregated in the composition after 30 days standing.

### Examples 10-14

### Preparation of Coating Compositions

Raw material as shown in Table 5 were mixed sequentially and agitated at high speed until fully dissolved to obtain a coating composition. Specific components and their contents are listed in the following Table 5. All units of contents presented in Table 5 are parts by weight. The components as shown in Table 5 are:

polyurethane, trade name: Etercure 6112-100;

polyurethane, trade name: Etercure 6195-100;

tripropylene glycol diacrylate, trade name: EM223;

pentaerythritol triacrylate, trade name: EM 253;

photo initiator, trade name: Igarcure184, manufactured by Ciba Company;

organic silicon leveling agent, trade name: BYK 3570, manufactured by BYK Chemical Company; and

mixed solvent:

butyl acetate: ethyl acetate: isopropanol: n-butanol=5:1:2:2 (weight ratio).

TABLE 5
components and their contents of the coating composition in Examples
10-14

| | Example No. | | | | |
|---|---|---|---|---|---|
| | 10 | 11 | 12 | 13 | 14 |
| Composition | — | Example 1 | Example 2 | Example 3 | Example 4 |
| Source | | | | | |
| Content of | 0 | 5 | 5 | 5 | 5 |
| composition | | | | | |
| Content of | 14.5 | 14.5 | 14.5 | 14.5 | 14.5 |
| Etercure | | | | | |
| 6112-100 | | | | | |
| Content of | 40 | 40 | 40 | 40 | 40 |
| Etercure | | | | | |
| 6195-100 | | | | | |
| Content of | 30 | 30 | 30 | 30 | 30 |
| EM 235 | | | | | |
| Content of | 10 | 5 | 5 | 5 | 5 |
| EM 223 | | | | | |
| Content of | 5 | 5 | 5 | 5 | 5 |
| Igarcure184 | | | | | |
| Content of | 0.5 | 0.5 | 0.5 | 0.5 | 0.5 |
| BYK 3570 | | | | | |
| Mixed solvent | 100 | 100 | 100 | 100 | 100 |
| Total content | 200 | 200 | 200 | 200 | 200 |

### Examples 15-19

### Preparation of Plate and their Property Tests

Black ABS substrate was provided. The coating compositions as shown in Table 5 were spray coated on the substrate to 20 μm, and then cured with a curing rate of 3.5 m/min to obtain a coating layer. Wherein, the coating layer of Example 15 was prepared with the coating composition of Example 10, and the coating layers of Examples 16-19 were respectively prepared with the coating compositions of Examples 11-14. After curing, the properties of the coating layers were measured by the following methods:

Hardness Test (ASTM D3363-100):

After fully-curing the coating layer, the hardness was measured by using a pencil (Mitsubishi Pencil Co., Ltd.) with a 1 kg-weighted trolley. The hardness of the coating layer was lower than the hardness of the pencil when the coating layer was scratched. Two hardness values of the pencils were recorded when scratching the coating layer.

Gloss Test (ASTM D523-89):

The coating layer was rod coated on the substrate, and measured with a gloss meter (60°, BYK Gardner varnish film gloss meter) at 4 positions to obtain its average gloss.

Solvent-Resistance Test (ASTM D 5402):

After the coating layer was fully coated, the coating layer was wiped back and forth by a solvent-resistant instrument with a force of 500 g until wear and crazing appeared.

Steel Wool-Resistance Test:

After the coating layer was fully cured, the coating layer was wiped with a force of 1 kg by using 0# or 0000# steel wool back and forth until fog and floating appeared.

Leveling Property:

The leveling property was determined as “good” if no orange peel or shrinkage was observed by naked eye.

Slip Smoothness Property:

The slip smoothness property was determined as “good” if no bump was felt by hands.

TABLE 6
test results of the coating layer comprised in the plate in Examples
15-19

| | Example | Example | Example | Example | Example |
|---|---|---|---|---|---|
| Test Items | 15 | 16 | 17 | 18 | 19 |
| Pencil | HB | F | F | F | F |
| Hardness | | | | | |
| Steel wool | 50 g | 500 g | 550 g | 550 g | 550 g |
| resistance/ | | | | | |
| 0000# | | | | | |
| Steel wool | 75 g | 500 g | 550 g | 600 g | 600 g |
| resistance/0# | | | | | |
| Solvent- | 30 | 150 | 154 | 150 | 155 |
| resistance/ | | | | | |
| times | | | | | |
| Leveling | Good | Good | Good | Good | Good |
| (naked-eye | | | | | |
| determina- | | | | | |
| tion) | | | | | |
| Slip | Good | Good | Good | Good | Good |
| smoothness | | | | | |
| Gloss (60°) | 96.7 | 95.8 | 96.4 | 96.3 | 95.7 |

As shown in Table 6, the hardness and scratch-resistance of the coating layers, which were made from the coating compositions including the compositions of the present invention, were significantly improved in comparison with the testing results of Example 15.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A composition, comprising:
(a) inorganic particles being spherical and having an average particle size ranging from 10 nanometers to 999 nanometers;
(b) a dispersant comprising an inorganic dispersant and a polymer dispersant; and
(c) an organic binding agent;
wherein the inorganic particles have a specific gravity represented by s1, the inorganic dispersant has a specific gravity represented by s2, 0.05<s2/s1<1, the total amount of the inorganic particles and the inorganic dispersant ranges from 0.5 to 70 parts by weight, the amount of the polymer dispersant ranges from 0.1 to 20 parts by weight, and the amount of the organic binding agent ranges from 10 to 98 parts by weight.

2. The composition as claimed in claim 1, wherein the weight ratio of the inorganic dispersant to the inorganic particles ranges from 0.02:1 to 10:1.

3. The composition as claimed in claim 1, wherein the overall weight of the composition ranges from 80 to 120 parts by weight.

4. The composition as claimed in claim 1, wherein the overall weight of the composition ranges from 90 to 110 parts by weight.

5. The composition as claimed in claim 1, wherein the amount of the inorganic particles ranges from 0.25 to 50 parts by weight based on the overall weight of the composition being 100 parts by weight.

6. The composition as claimed in claim 1, wherein the inorganic particles are selected from the group consisting of: metallic oxide particles, ceramic particles and the combinations thereof.

7. The composition as claimed in claim 1, wherein the inorganic dispersant is selected from the group consisting of: aluminum oxide, silicon dioxide, zinc oxide, zirconium dioxide, cerium dioxide, titanium dioxide and the combinations thereof.

8. The composition as claimed in claim 6, wherein the inorganic dispersant is selected from the group consisting of: aluminum oxide, silicon dioxide, zinc oxide, zirconium dioxide, cerium dioxide, titanium dioxide and the combinations thereof.

9. The composition as claimed in claim 1, wherein the amount of the inorganic dispersant ranges from 0.1 to 30 parts by weight based on the overall weight of the composition being 100 parts by weight.

10. The composition as claimed in claim 1, wherein the polymer dispersant is selected from the group consisting of: polyacrylate, polyester, polyamide, polyurethane, polyimide, polyurea, polyether, polysiloxane, fatty acid ester and the combinations thereof.

11. The composition as claimed in claim 1, wherein the organic binding agent is selected from the group consisting of: polyether, polyurethane, acrylate, unsaturated polyester resin, epoxy compound, polyamide, melamine, polyolefin, polystyrene, polysiloxane resin, fluorinated polymer resin and the combinations thereof.

12. A method of preparing the composition as claimed in claim 1, comprising the steps of:
(a) mixing the polymer dispersant and the organic binding agent to form a first mixture;
(b) adding the inorganic particles and the inorganic dispersant into the first mixture obtained in the step (a) to form a second mixture; and
(c) wet grinding the second mixture obtained in the step (b) to obtain the composition.

13. The method as claimed in claim 12, wherein the step (c) further comprises the step of wet grinding the second mixture obtained in the step (b) with grinding media having a particle size ranging from 0.01 millimeters to 1 millimeter.

14. The method as claimed in claim 12, wherein the weight ratio of the inorganic dispersant to the inorganic particles ranges from 0.02:1 to 10:1.

15. The composition as claimed in claim 12, wherein the overall weight of the composition ranges from 80 to 120 parts by weight.

16. The composition as claimed in claim 12, wherein the amount of the inorganic particles ranges from 0.25 to 50 parts by weight and the amount of the inorganic dispersant ranges from 0.1 to 30 parts by weight based on the overall weight of the composition being 100 parts by weight.

17. The composition as claimed in claim 12, wherein the inorganic dispersant is selected from the group consisting of: aluminum oxide, silicon dioxide, zinc oxide, zirconium dioxide, cerium dioxide, titanium dioxide and the combinations thereof, and the polymer dispersant is selected from the group consisting of: polyacrylate, polyester, polyamide, polyurethane, polyimide, polyurea, polyether, polysiloxane, fatty acid ester and the combinations thereof.

18. The composition as claimed in claim 12, wherein the organic binding agent is selected from the group consisting of: polyether, polyurethane, acrylate, unsaturated polyester resin, epoxy compound, polyamide, melamine, polyolefin, polystyrene, polysiloxane resin, fluorinated polymer resin and the combinations thereof.

19. An anti-scratch and wear-resistant plate, comprising:
a substrate; and
a coating layer;
wherein the coating layer is cured by a coating composition coated on at least one surface of the substrate, and the coating composition comprises the composition as claimed in claim 1.

20. The anti-scratch and wear-resistant plate as claimed in claim 19, wherein the weight ratio of the inorganic dispersant to the inorganic particles ranges from 0.02:1 to 10:1.

21. The anti-scratch and wear-resistant plate as claimed in claim 19, wherein the overall weight of the composition ranges from 80 to 120 parts by weight.

22. The anti-scratch and wear-resistant plate as claimed in claim 19, wherein the amount of the inorganic particles ranges from 0.25 to 50 parts by weight and the amount of the inorganic dispersant ranges from 0.1 to 30 parts by weight based on the overall weight of the composition being 100 parts by weight.

23. The anti-scratch and wear-resistant plate as claimed in claim 19, wherein the inorganic dispersant is selected from the group consisting of: aluminum oxide, silicon dioxide, zinc oxide, zirconium dioxide, cerium dioxide, titanium dioxide and the combinations thereof, and the polymer dispersant is selected from the group consisting of: polyacrylate, polyester, polyamide, polyurethane, polyimide, polyurea, polyether, polysiloxane, fatty acid ester and the combinations thereof.

24. The anti-scratch and wear-resistant plate as claimed in claim 19, wherein the organic binding agent is selected from the group consisting of: polyether, polyurethane, acrylate, unsaturated polyester resin, epoxy compound, polyamide, melamine, polyolefin, polystyrene, polysiloxane resin, fluorinated polymer resin and the combinations thereof.
